(19) United States
(12) Patent Application Publication
(10) Pub. No.: US 2014/0286722 A1
(43) Pub. Date: Sep. 25, 2014

(54) SHELTER TIE-DOWN STOPS

(71) Applicant: International Truck Intellectual Property Company, (US)

(72) Inventors: Glenn Surratt, Madison Heights, MI (US); Greg Gac, Troy, MI (US)

(73) Assignee: International Truck Intellectual Property Company, Lisle, IL (US)

(21) Appl. No.: 13/849,141

(22) Filed: Mar. 22, 2013

(51) Int. Cl. B60P 7/08

(52) U.S. Cl. CPC B60P 7/08
USPC 410/2

(57) ABSTRACT

A retaining device and assembly for securing a modular structure to a vehicle bed is disclosed. The assembly includes a main body, a retaining portion forming an end of the main body, and means for securing the main body to the vehicle bed, wherein the secured main body and retaining portion prevent the structure from moving while positioned within the vehicle bed. The retaining assembly is compatible with existing fasteners or tie-downs on the cargo bed of the vehicle; therefore, no additional modifications are needed to the cargo bed to accommodate the retaining assembly.

### TECHNICAL FIELD

The present device and assembly relate to securing a modular component to a vehicle for transport. More specifically, the present device and assembly relate to securing and retaining a modular structure, such as a tactical shelter, to a vehicle cargo bed using existing fasteners or tie-downs without requiring additional modifications to the cargo bed.

### BACKGROUND

Military commercial off-the-shelf vehicles, or MilCOTS, have become common place in today's military fleet. MilCOTS are medium logistical vehicles for Regular and Reserve Forces used in roles varying from domestic to deployed operations. These medium-weight trucks form the backbone of ground transport for Regular and Reserve Forces, getting supplies and equipment where they are needed in the most efficient way possible.

MilCOTS are often employed to carry mobile tactical shelters and containerized systems. These shelters are lightweight, high strength and insulated for all weather conditions. A typical shelter is constructed as a box, with six panels, four sides, a roof and a floor. Tactical shelters are frequently used to house communications and other transportable electronic equipment.

Shelters and other modular structures are often secured to cargo beds using cable assemblies. Wooden blocks were frequently used to limit the movement of the shelter while on the vehicle. However, because the shape and size of the shelters may vary, there is a need to secure the shelter to the vehicle bed in a convenient manner during transport, using a retaining assembly adjustable to the size of the shelter. In addition to securing the shelter, the retaining assembly should prevent the shelter from moving in fore-aft and cross-car directions when the vehicle is moving. The present retaining assembly, and in particular, the stop portion of the assembly, is adjustable to fit various sizes of shelters. In addition, the present assembly is useful without having to modify the cargo bed in any manner, and thus is easily attached and detached. The present retaining assembly may be used in other applications, such as wheel or blocking chocks and jacking clamps. The present retaining device and assembly provides these and other advantages.

### SUMMARY

There is disclosed herein a device and assembly, each of which avoids the disadvantages of prior devices and assemblies while affording additional structural and operating advantages.

Generally speaking, a retaining device and assembly for securing a modular structure to a vehicle bed is disclosed. The retaining device and assembly can be used with existing fasteners or tie-downs in a cargo bed, and prevents the modular structure from moving in fore-aft and cross-car directions when the vehicle is moving.

In an embodiment, a retaining assembly for securing a modular structure to a vehicle bed, is disclosed. The assembly includes a main body, a retaining portion forming an end of the main body, and means for securing the main body to the vehicle bed, wherein the secured main body and retaining portion prevent the structure from moving while positioned within the vehicle bed.

A method for securing a modular structure to a vehicle bed of a vehicle is also disclosed. The method includes the steps of providing a vehicle bed with a fastener formed therein, providing a stop assembly for retaining the modular structure within the vehicle bed, securing the stop assembly to the vehicle bed through the fastener; and using the stop assembly to engage and retain the modular structure within the vehicle bed during movement of the vehicle.

These and other features and advantages of the retaining assembly and method can be more readily understood from the following detailed discussion with reference to the appended drawing figures.

### BRIEF DESCRIPTION OF THE DRAWINGS

FIG. 1 is a perspective view of an embodiment of a standard tactical shelter utilizing an embodiment of the present retaining assembly;

FIG. 2 is a perspective view of the present retaining assembly;

FIG. 3 is a perspective view of the main body and stop portion of the retaining assembly;

FIG. 4 is a bottom view of the main body and stop portion of the retaining assembly;

FIGS. 5A is top view of an embodiment of the stop portion and shims;

FIG. 5B is a top view of another embodiment of the stop portion and shims;

FIG. 6 is an end view of the main body engaged on a fastener and the retaining bracket;

FIG. 7 is a perspective view of the retaining brackets; and

FIG. 8 is a perspective view of the retaining assembly with the retaining brackets engaged therein.

### DETAILED DESCRIPTION

Referring to FIGS. 1-8, there is illustrated an embodiment of a retaining assembly, generally designated by the numeral 10, as well as the components thereof The present retaining assembly 10 is useful in securing a modular structure, such as a tactical shelter, to a cargo bed of a medium logistical vehicle (not shown). The retaining assembly 10 is compatible with existing fasteners or tie-downs on the cargo bed of the vehicle; therefore, no additional modifications are needed to the cargo bed to accommodate the retaining assembly.

FIG. 1 illustrates a typical tactical shelter 100 secured to a flatbed 102 using the retaining assembly 10 of the present disclosure. The shelter 100 is secured to the flatbed 102 using a plurality of cables 104, and prevented from moving in a fore-aft and cross-car direction though the use of the retaining assembly 10.

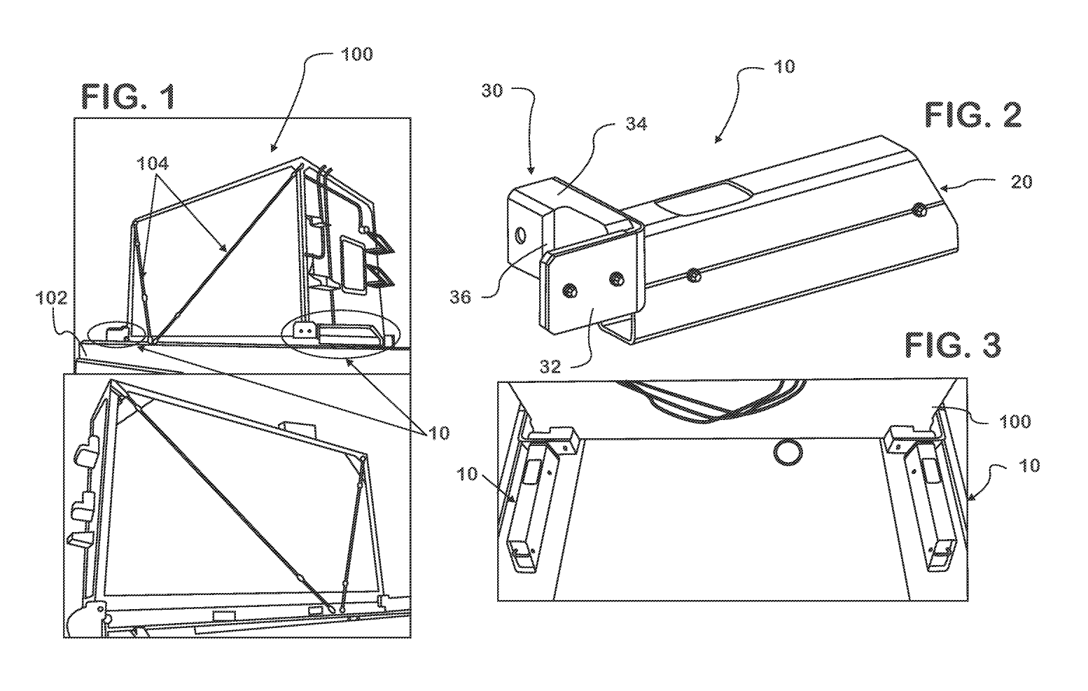

FIGS. 2-4 illustrate the components of the retaining assembly 10. Specifically, the retaining assembly 10 includes a main body 20 and a retaining portion 30, located on an end of the main body. The main body 20 can be constructed from any durable material, including steel. In addition, the main body 20 can have any suitable shape, including a tubular or rectangular shape as illustrated in the present drawings and disclosure.

Located on an end of the main body 20 is the retaining portion 30. The retaining portion 30 includes a stop plate 32 and at least one stop block 34. The stop plate 32 and stop blocks 34 are configured to form an engagement section 36 for seating a corner of the shelter 100 when the shelter is positioned on the cargo bed and into the retaining assembly. In FIGS. 2 and 3, the stop plate 32 is shown having an L-shape to accommodate a corner of the shelter, but it should be understood that the shape of the stop plate may vary depending on the corresponding shape of the shelter and/or the main body. The stop plate 32 can be secured to the end of the main body 20 through any known fastener means, or through welding.

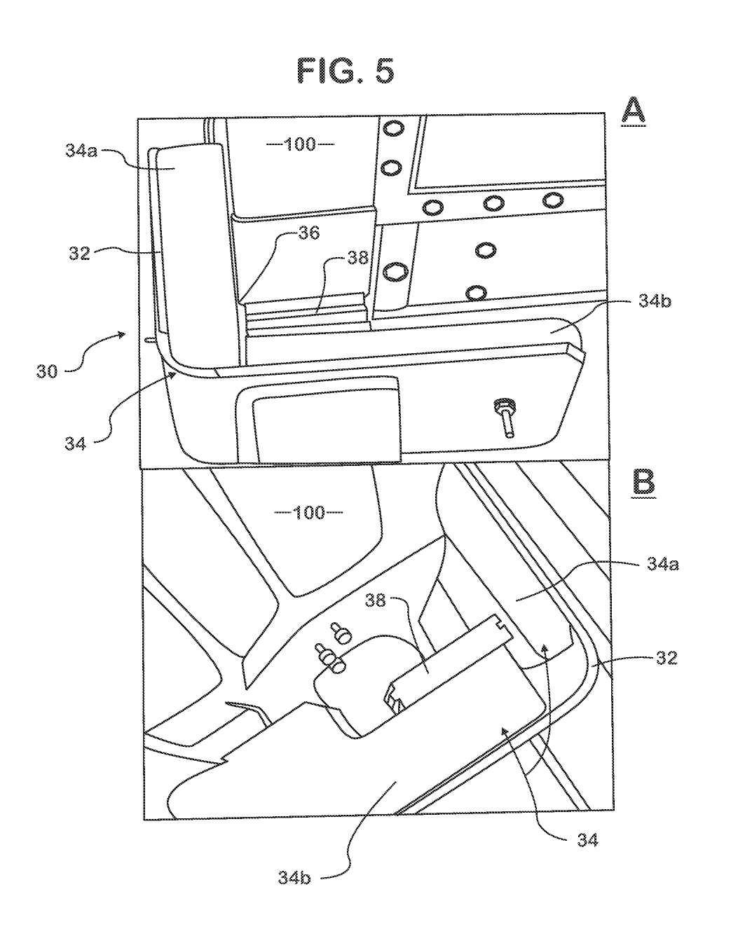

The retaining portion 30 also includes at least one stop block 34. The stop block or blocks 34 are attached to the stop plate 32, as shown in FIGS. 5A and B, each of which show different embodiments of the stop blocks. For example, a first stop block 34a is positioned along one side of the stop plate 32, while a second stop block 34b is positioned along a second side of the stop plate. The juncture where the stop blocks 34 meet within the stop plate 32 form the engagement section 36 for the corner of the shelter. As shown in FIGS. 5A and B, the stop blocks 34a and b may have different shapes to accommodate the shape of the shelter. In addition, the number of stop blocks 34 used and the position of the stop blocks with the stop plate 32 may vary depending on the size and shape of a particular shelter structure. The stop blocks 34 can be constructed from any durable material, including plastics, which are easily replaceable without significant cost.

In addition to the stop blocks 34, the retaining assembly may include a plurality of shims 38. As shown in FIGS. 5A and B, the shims 38 can be used to fill any remaining space or gap between the stop blocks 34 and the edge or corner of the shelter 100, thus creating a tighter fit between the stop blocks and the edge of the shelter. Use of the stop blocks 34 and a varying number of shims 38 make it possible to accommodate various types and sizes of shelters. The shims 38 may be constructed from a material similar to the stop blocks, such as plastic.

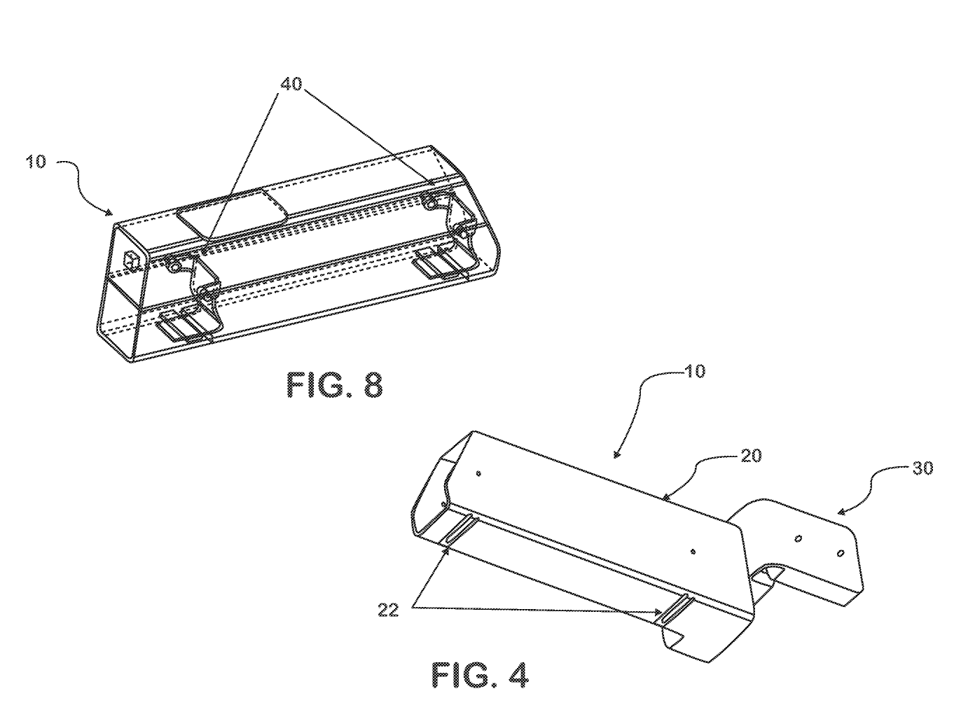

As shown in FIGS. 4, 6 and 7, attaching the retaining assembly 10 to a cargo bed of a vehicle is a simple process. As shown in FIG. 4, the main body 20 includes at least one opening or slot 22 in the bottom section of the main body. The slot 22 receives a securing means including a fastener 24, which is already incorporated into the cargo bed of the vehicle. Because the fastener 24 is already a standard component of the cargo bed, no further modifications of the cargo bed are required to accommodate the retaining assembly 10. Thus, the present retainer assembly 10 provides easy installation and disassembly, making it useful in the field.

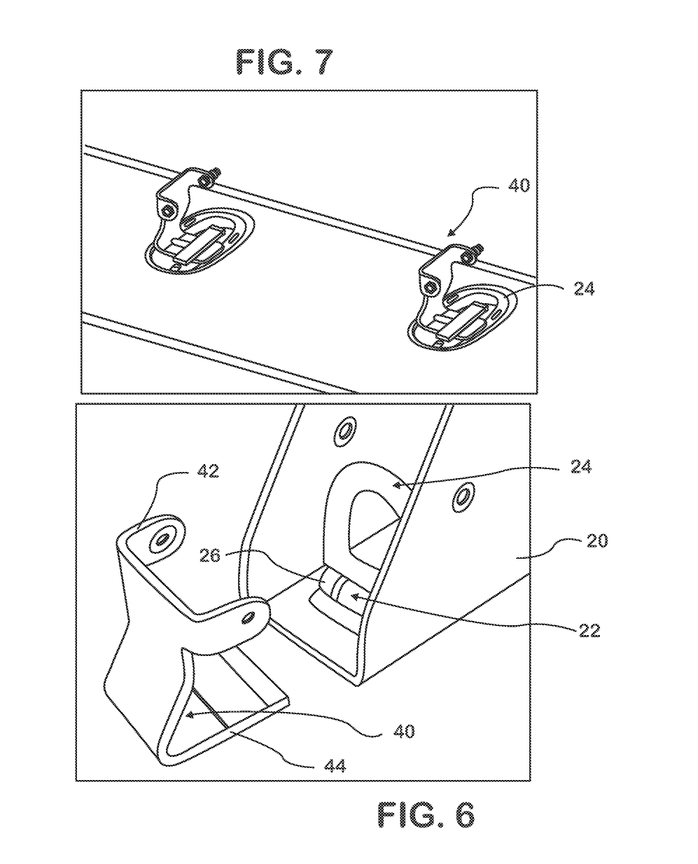

In an embodiment, the securing means or fastener 24 is a D-ring. The D-ring is inserted through one of the slots 22 in the bottom of the main body 20, to initially secure the retaining assembly 10 to the cargo bed. A retaining bracket 40 as shown in FIG. 6 is also part of the securing means, and is employed to secure the main body 20 to the cargo bed. Specifically, the retaining bracket 40 includes two arms 42 and a base 44. The base 44 slides under an opening 26 beneath the D-ring 24, while the arms 42 of the bracket slide into the interior of the main body 20. The arms 42 are then secured to the interior walls of the main bracket using known fastening means, such as a screw (FIG. 8). Incorporating the retaining bracket 40 into the D-ring fastener 24 secures the retaining assembly 10 to the cargo bed.

Securing the retaining assembly 10 in the manner described using the cargo bed fastener 24 and the retaining bracket 40, ensures that the retaining assembly meets or exceeds design and ultimate load limits set by known standards. For example, the design limit load is the applied force or maximum probable force that a provision, including its connecting structural members, will be subjected to in its most severe transport environment. For lifting, the design limit load is the static load times the load factor. For equipment tie-down, the static load, the design limit load is 4.0 times the gross weight in the longitudinal direction, 2.0 times the gross weight in the vertical direction, and 1.5 times the gross weight in the lateral direction. The ultimate load is the force (not less than the design limit load times 1.5) that a provision, including its connecting structural members, can sustain without breaking, rupturing, or otherwise becoming unusable. The present retaining assembly and its components are designed to meet the required work load limits and peak loading requirements.

The present retaining or stop assembly 10 is useful in a method for securing a modular structure to a cargo bed of a vehicle. The method includes securing the stop assembly 10 to the cargo bed of a vehicle having a standard fastener incorporated therein. The stop assembly engages and retains the modular structure within the cargo bed during movement of the vehicle. Finally, the stop assembly 10 is adjustable to accommodate modular structures of varying sizes.

1. A retaining assembly for securing a modular structure to a vehicle cargo bed, the assembly comprising:
a main body;
a retaining portion forming an end of the main body; and,
means for securing the main body to the vehicle bed, wherein the secured main body and retaining portion prevent the structure from moving while positioned within the cargo bed.

2. The retaining assembly of claim 1, wherein the main body includes a plurality of slots within a bottom section of the main body.

3. The retaining assembly of claim 2, wherein the slots receive the securing means to mount the main body to the cargo bed.

4. The retaining assembly of claim 1, wherein the retaining portion includes a stop.

5. The retaining assembly of claim 4, wherein the stop includes a stop plate secured to an end of the main body.

6. The retaining assembly of claim 5, wherein the stop further includes a stop block secured to the stop plate.

7. The retaining assembly of claim 6, wherein the stop plate and the stop block form an engagement section for engaging a corner of the structure.

8. The retaining assembly of claim 1, wherein the securing means includes a fastener formed within the cargo bed.

9. The retaining assembly of claim 8, wherein the fastener engages at least one slot within the bottom section of the main body mounting the main body to the cargo bed.

10. The retaining assembly of claim 8, wherein the fastener includes a D-ring structure.

11. The retaining assembly of claim 8, wherein the securing means further includes a retaining bracket.

12. The retaining assembly of claim 11, wherein the retaining bracket engages the fastener and attaches to the main body securing the main body to the cargo bed.

13. A method for securing a modular structure to a cargo bed of a vehicle, the method comprising the steps of:
providing a cargo bed with a fastener formed therein;
providing a stop assembly for retaining the modular structure within the cargo bed;
securing the stop assembly to the cargo bed through the fastener device; and
using the stop assembly to engage and retain the modular structure within the cargo bed during movement of the vehicle.

14. The method of claim 13, wherein the method of securing the stop assembly to the cargo bed further comprises the step of engaging the fastener device through an opening in the stop assembly and adding a second fastener device for engagement with the first fastener device, wherein the first and second fastener devices retain the stop assembly and modular structure within the cargo bed.
